(19) United States
(12) Patent Application Publication
(10) Pub. No.: US 2006/0245601 A1
(43) Pub. Date: Nov. 2, 2006

(54) Robust localization and tracking of simultaneously moving sound sources using beamforming and particle filtering

(76) Inventors: Francois Michaud, Rock Forest (CA); Jean-Marc Valin, Sherbrooke (CA); Jean Rouat, Sainte-Foy (CA)

Correspondence Address: Muirhead and Saturnelli, LLC, 200 Friberg Parkway, Suite 1001, Westborough, MA, 01581, US

(21) Appl. No.: 11/116,117

(22) Filed: Apr. 27, 2005

(51) Int. Cl. H04R 3/00

(52) U.S. Cl. 381/92

(57) ABSTRACT

The present invention relates to a system for localizing at least one sound source, comprising a set of spatially spaced apart sound sensors to detect sound from the at least one sound source and produce corresponding sound signals, and a frequency-domain beamformer responsive to the sound signals from the sound sensors and steered in a range of directions to localize, in a single step, the at least one sound source. The present invention is also concerned with a system for tracking a plurality of sound sources, comprising a set of spatially spaced apart sound sensors to detect sound from the sound sources and produce corresponding sound signals, and a sound source particle filtering tracker responsive to the sound signals from the sound sensors for simultaneously tracking the plurality of sound sources. The invention still further relates to a system for localizing and tracking a plurality of sound sources, comprising a set of spatially spaced apart sound sensors to detect sound from the sound sources and produce corresponding sound signals; a sound source detector responsive to the sound signals from the sound sensors and steered in a range of directions to localize the sound sources, and a particle filtering tracker connected to the sound source detector for simultaneously tracking the plurality of sound sources.

### FIELD OF THE INVENTION

The present invention relates to a sound source localizing method and system, a sound source tracking method and system and a sound source localizing and tracking method and system.

### BACKGROUND OF THE INVENTION

Sound source localization is defined as the determination of the coordinates of sound sources in relation to a point in space. The auditory system of living creatures provides vast amounts of information about the world, such as localization of sound sources. For example, human beings are able to focus their attention on surrounding events and changes, such as a cordless phone ringing, a vehicle honking, a person who is speaking, etc.

Hearing complements other senses such as vision since it is omnidirectional, capable of working in the dark and not incapacitated by physical structure such as walls. Those who do not suffer from hearing impairments can hardly imagine spending a day without being able to hear, especially when moving in a dynamic and unpredictable world. Marschark [M. Marschark, “Raising and Educating a Deaf Child”, Oxford University Press, 1998, http://www.rit.edu/memrtl/course/interpreting/modules/modulelist.htm] has even suggested that although deaf children have similar IQ results compared to other children, they do experience more learning difficulties in school. Obviously, intelligence manifested by autonomous robots would surely be improved by providing them with auditory capabilities.

To localize sound, the human brain combines timing (more specifically delay or phase) and amplitude information related to the sound perceived by the two ears, sometimes in addition to information from other senses. However, localizing sound sources using only two sensing inputs is a challenging task. The human auditory system is very complex and resolves the problem by taking into consideration the acoustic diffraction around the head and the ridges of the outer ear. Without this ability, localization of sound through a pair of microphones is limited to azimuth only without distinguishing whether the sounds come from the front or the back. It is even more difficult to obtain high precision readings when the sound source and the two microphones are located along the same axis.

Fortunately, robots did not inherit the same limitations as living creatures; more than two microphones can be used. Using more than two microphones improves the reliability and accuracy in localizing sounds within three dimensions (azimuth and elevation). Also, detection of multiple signals provides additional redundancy, and reduces uncertainty caused by the noise and non-ideal conditions such as reverberation and imperfect microphones.

Signal processing research that addresses artificial audition is often geared toward specific tasks such as speaker tracking for videoconferencing [B. Mungamuru and P. Aarabi, “Enhanced sound localization”, IEEE Transactions on Systems, Man, and Cybemetics Part B, vol. 34, no. 3, 2004, pp. 1526-1540]. For that reason, artificial audition on mobile robots is a research area still in its infancy and most of the work has been done in relation to localization of sound sources and mostly using only two microphones. This is the case of the SIG robot that uses both IPD (Inter-aural Phase Difference) and IID (Inter-aural Intensity Difference) to localize sound sources [K. Nakadai, D. Matsuura, H. G. Okuno, and H. Kitano, “Applying scattering theory to robot audition system: Robust sound source localization and extraction”, in Proceedings IEEE/RSJ International Conference on Intelligent Robots and Systems, 2003, pp. 1147-1152]. The binaural approach has limitations for evaluating elevation and usually, the front-back ambiguity cannot be resolved without resorting to active audition [K. Nakadai, T. Lourens, H. G. Okuno, and H. Kitano, “Active audition for humanoid”, in Proceedings of the Seventeenth National Conference on Artificial Intelligence (AAAI), 2000, pp. 832-839].

More recently, approaches using more than two microphones have been developed. One of these approaches uses a circular array of eight microphones to locate sound sources [F. Asano, M. Goto, K. Itou, and H. Asoh, “Real-time source localization and separation system and its application to automatic speech recognition”, in Proc. EUROSPEECH, 2001, pp. 1013-1016]. The article of [J.-M. Valin, F. Michaud, J. Rouat, and D. Létourneau, “Robust sound source localization using a microphone array on a mobile robot”, in Proceedings IEEE/RSJ International Conference on Intelligent Robots and Systems, 2003, pp. 1228-1233] presents a method using eight microphones for localizing a single sound source where TDOA (Time Delay Of Arrival) estimation was separated from DOA (Direction Of Arrival) estimation. Kagami et al. [S. Kagami, Y. Tamai, H. Mizoguchi, and T. Kanade, “Microphone array for 2D sound localization and capture”, in Proceedings IEEE International Conference on Robotics and Automation, 2004, pp. 703-708] reports a system using 128 microphones for 2D sound localization of sound sources: obviously, it would not be practical to include such a large number of microphones on a mobile robot.

Most of the work so far on localization of sound sources does not address the problem of tracking moving sources. The article of [D. Bechler, M. Schlosser, and K. Kroschel, “System for robust 3D speaker tracking using microphone array measurements”, in Proceedings IEEE/RSJ International Conference on Intelligent Robots and Systems, 2004, pp. 2117-2122] has proposed to use a Kalman filter for tracking a moving source. However the proposed approach assumes that a single source is present. In the past years, particle filtering [M. S. Arulampalam, S. Maskell, N. Gordon, and T. Clapp, “A tutorial on particle filters for online nonlinear/non-gaussian bayesian tracking”, IEEE Transactions on Signal Processing, vol. 50, no. 2, pp. 174-188, 2002] (a sequential Monte Carlo method) has been increasingly popular to resolve object tracking problems. The articles of [D. B. Ward and R. C. Williamson, “Particle filtering beamforming for acoustic source localization in a reverberant environment”, in Proceedings IEEE International 33 Conference on Acoustics, Speech, and Signal Processing, vol. II, 2002, pp. 1777-1780], [D. B. Ward, E. A. Lehmann, and R. C. Williamson, “Particle filtering algorithms for tracking an acoustic source in a reverberant environment”, IEEE Transactions on Speech and Audio Processing, vol. 11, no. 6, 2003] and [J. Vermaak and A. Blake, “Nonlinear filtering for speaker tracking in noisy and reverberant environments”, in Proceedings IEEE International Conference on Acoustics, Speech, and Signal Processing, vol. 5, 2001, pp. 3021-3024] use this technique for tracking single sound sources. Asoh et al. in [H. Asoh, F. Asano, K. Yamamoto, T. Yoshimura, Y. Motomura, N. Ichimura, I. Hara, and J. Ogata, “An application of a particle filter to bayesian multiple sound source tracking with audio and video information fusion”] even suggested to use this technique for mixing audio and video data to track speakers. But again, the use of this technique is limited to a single source due to the problem of associating the localization observation data to each of the sources being tracked. This problem is referred to as the source-observation assignment problem.

Some attempts have been made to define multi-modal particle filters in [J. Vermaak, A. Doucet, and P. Pérez, “Maintaining multi-modality through mixture tracking”, in Proceedings International Conference on Computer Vision (ICCV), 2003, pp. 1950-1954], and the use of particle filtering for tracking multiple targets is demonstrated in [J. MacCormick and A. Blake, “A probabilistic exclusion principle for tracking multiple objects”, International Journal of Computer Vision, vol. 39, no. 1, pp. 57- 71, 2000], [C. Hue, J.-P. L. Cadre, and P. Perez, “A particle filter to track multiple objects”, in Proceedings IEEE Workshop on Multi-Object Tracking, 2001, pp. 61-68] and [J. Vermaak, S. Godsill, and P. Pérez, “Monte carlo filtering for multi-target tracking and data association”, IEEE Transactions on Aerospace and Electronic Systems, 2005]. However, so far, the technique has not been applied to sound source tracking.

### SUMMARY OF THE INVENTION

In accordance with the present invention, there is provided a method for localizing at least one sound source, comprising detecting sound from the at least one sound source through a set of spatially spaced apart sound sensors to produce corresponding sound signals, and localizing, in a single step, the at least one sound source in response to the sound signals. Localizing the at least one sound source includes steering a frequency-domain beamformer in a range of directions.

In accordance with the present invention, there is also provided a method for tracking a plurality of sound sources, comprising detecting sound from the sound sources through a set of spatially spaced apart sound sensors to produce corresponding sound signals, and simultaneously tracking the plurality of sound sources, using particle filtering responsive to the sound signals from the sound sensors.

In accordance with the present invention, there is further provided a method for localizing and tracking a plurality of sound sources, comprising detecting sound from the sound sources through a set of spatially spaced apart sound sensors to produce corresponding sound signals, localizing the sound sources in response to the sound signals wherein localizing the sound sources includes steering in a range of directions a sound source detector having an output, and simultaneously tracking the plurality of sound sources, using particle filtering, in relation to the output from the sound source detector.

The present invention also relates to a system for localizing at least one sound source, comprising a set of spatially spaced apart sound sensors to detect sound from the at least one sound source and produce corresponding sound signals, and a frequency-domain beamformer responsive to the sound signals from the sound sensors and steered in a range of directions to localize, in a single step, the at least one sound source.

The present invention further relates to a system for tracking a plurality of sound sources, comprising a set of spatially spaced apart sound sensors to detect sound from the sound sources and produce corresponding sound signals, and a sound source particle filtering tracker responsive to the sound signals from the sound sensors for simultaneously tracking the plurality of sound sources.

The present invention still further relates to a system for localizing and tracking a plurality of sound sources, comprising a set of spatially spaced apart sound sensors to detect sound from the sound sources and produce corresponding sound signals, a sound source detector responsive to the sound signals from the sound sensors and steered in a range of directions to localize the sound sources, and a particle filtering tracker connected to the sound source detector for simultaneously tracking the plurality of sound sources.

The foregoing and other objects, advantages and features of the present invention will become more apparent upon reading of the following non restrictive description of an illustrative embodiment thereof, given with reference to the accompanying drawings.

### BRIEF DESCRIPTION OF THE DRAWINGS

In the appended drawings:

FIG. 1 is a schematic block diagram of a non-restrictive illustrative embodiment of the system for localizing and tracking a plurality of sound sources according to the present invention;

FIG. 2 is a schematic flow chart showing how the non-restrictive illustrative embodiment of the sound source localizing and tracking method according to the present invention calculates the beamformer energy in the frequency domain;

FIG. 3 is a schematic block diagram of a delay-and-sum beamformer forming part of the non-restrictive illustrative embodiment of the sound source localizing and tracking system according to the present invention;

FIG. 4 is a schematic flow chart showing how the non-restrictive illustrative embodiment of the sound source localizing and tracking method according to the present invention calculates cross-correlations by averaging cross-power spectra of the sound signals over a time period;

FIG. 5 is a schematic block diagram of a calculator of cross-correlations forming part of the delay-and-sum beamformer of FIG. 3;

FIG. 6 is a schematic representation of a recursive subdivision (two levels) of a triangular element in view of defining a uniform triangular grid on the surface of a sphere;

FIG. 7 is a schematic flow chart showing how the non-restrictive illustrative embodiment of the sound source localizing and tracking method according to the present invention searches for a direction on the spherical, triangular grid of FIG. 6;

FIG. 8 is a is a schematic block diagram of a device for searching for a direction on the spherical, triangular grid of FIG. 6, forming part of the non-restrictive illustrative embodiment of the sound source localizing and tracking system according to the present invention;

FIG. 9 is a graph of the beamformer output probabilities Pq for azimuth as a function of time, with observations with P_{q}>0.5, 0.2<P_{q}<0.5 and P_{q}<0.2;

FIG. 10 is a schematic flow chart showing particle-based tracking as used in the non-restrictive illustrative embodiment of the sound source localizing and tracking method according to the present invention;

FIG. 11 is a schematic block diagram of a particle-based sound source tracker forming part of the non-restrictive illustrative embodiment of the sound source localizing and tracking system according to the present invention;

FIG. 12 is a schematic diagram showing an example of assignment with two sound sources observed, one new source and one false detection, wherein the assignment can be described as ƒ({0,1,2,3})={1,−2,0,−1};

FIG. 13a is a graph illustrating an example of tracking of four moving sources, showing azimuth as a function of time with no delay;

FIG. 13b is a graph illustrating an example of tracking of four moving sources, showing azimuth as a function of time with delayed estimation (500 ms);

FIG. 14a is a schematic diagram showing an example of sound source trajectories wherein a robot is represented as an <<x>> and wherein the sources are moving;

FIG. 14b is a schematic diagram showing an example of sound source trajectories wherein the robot is represented as an <<x>> and the robot is moving;

FIG. 14c is a schematic diagram showing an example of sound source trajectories wherein the robot is represented as an <<x>> and wherein the trajectories of the sources intersect;

FIG. 15a is a graph showing four speakers moving around a stationary robot in a first environment (E1) and with a false detection shown at 81;

FIG. 15b is a graph showing four speakers moving around a stationary robot in a second environment (E2);

FIG. 16a is a graph showing two stationary speakers with a moving robot in the first environment (E1), wherein a false detection is indicated at 91;

FIG. 16b is a graph showing two stationary speakers with a moving robot in the second environment (E2), wherein a false detection is indicated at 92;

FIG. 17a is a graph showing two speakers' trajectories intersecting in front of a robot in the first environment (E1);

FIG. 17b is a graph showing two speakers' trajectories intersecting in front of the robot in the second environment (E2); and

FIG. 18 is a set of four graphs showing tracking of four sound sources using a predetermined configuration of microphones in the first environment (E1), for 4, 5, 6 and 7 microphones, respectively.

### DETAILED DESCRIPTION OF THE ILLUSTRATIVE EMBODIMENT

The non-restrictive illustrative embodiment of the present invention will be described in the following description. This illustrative embodiment used a non-restrictive approach based on a beamformer, for example a frequency-domain beamformer that is steered in a range of directions to detect sound sources. Instead of measuring TDOAs and then converting these TDOAs to a position, the localization of sound is performed in a single step. This single step approach makes the localization more robust, especially when an obstacle prevents one or more sound sensors, for example microphones from properly receiving the sound signals. The results of the localization are then enhanced by probability-based post-processing which prevents false detection of sound sources. This makes the approach according to the non-restrictive illustrative embodiment sensitive enough for simultaneously localizing multiple moving sound sources. This approach works for both far-field and near-field sound sources. Detection reliability, accuracy, and tracking capabilities of the approach have been validated using a mobile robot, with different types of sound sources.

In other words, combining TDOA and DOA estimation in a single step improves the system's robustness, while allowing localization of simultaneous sound sources. It is also possible to track multiple sound sources using particle filters by solving the above-mentioned source-observation assignment problem.

An artificial sound source localization and tracking method and system for a mobile robot can be used for three purposes:
1) localizing sound sources;
2) separating sound sources in order to process only signals that are relevant to a particular event in the environment; and
3) processing sound sources to extract useful information from the environment (like speech recognition).

1. System Overview

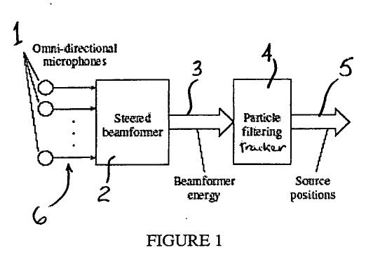

The artificial sound source localization and tracking system according to the non-restrictive illustrative embodiment is composed, as shown in FIG. 1, of three parts:
1) An array of microphones 1;
2) A steered beamformer including a memoryless localization algorithm 2 delivering an initial localization of the sound source(s) and a maximized output energy 3; and
3) A particle filtering tracker 4 responsive to the initial sound source localization and maximized output energy 3 for simultaneously tracking all the sound sources, prevent false sound source detection, and delivering sound source source positions 5.

The array of microphones 1 comprises a number, for example up to eight omnidirectional microphones mounted on the robot. Since the sound source localization and tracking system is designed for installation on a robot, there is no strict constraint on the position of the microphones 1. However, the positions of the microphones relative to each other, is known and measured with, for example, an accuracy of ≅0.5.

The sound signals such as 6 from the microphones 1 are supplied to the beamformer 2. The beamformer forms a spatial filter that is steered in all possible directions in order to maximize the output beamformer energy 3. The direction corresponding to the maximized output beamformer energy is retained as the direction or initial localization of the sound source or sources.

The initial localization performed by the steered beamformer 2, including the maximized output beamformer energy 3 is then supplied to the input of a post-processing stage, more specifically the particle filtering tracker 4 using a particle filter to simultaneously track all sound sources and prevent false detections.

The output (source positions 5) of the sound source localization and tracking system of FIG. 1 can be used to draw the robot's attention to the sound source. It can also be used as part of a source separation algorithm to isolate the sound coming from a single source.

2. Localization Using a Steered Beamformer

The basic idea behind the steered beamformer approach to source localization is to direct or steer a beamformer in a range of directions, for example all possible directions and look for maximal output. This can be done by maximizing the output energy of a simple delay-and-sum beamformer.

2.1 Delay-and-Sum Beamformer

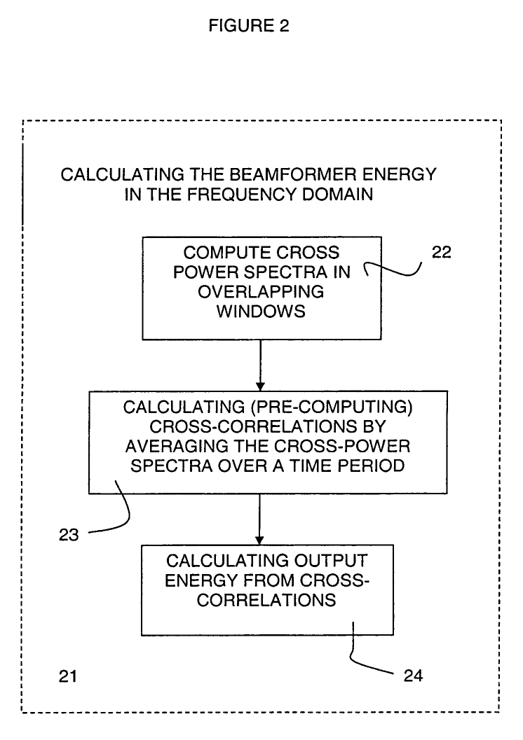

Operation 21 (FIG. 2)

The output of an M-microphone delay-and-sum beamformer is defined as:

$$y ( n ) = {\sum }_{m = 0}^{M - 1} {x}_{m} ( n - {τ}_{m} ) \qquad ( 1 )$$

where xₘ(n) is the signal from the m^{th} microphone and τₘ is the delay of arrival for that microphone. The output energy of the beamformer over a frame of length L is thus given by:

$$\begin{matrix}E = {\sum }_{n = 0}^{L - 1} {[ y ( n ) ]}^{2} \\ = {\sum }_{n = 0}^{L - 1} {[ {x}_{0} ( n - {τ}_{0} ) + … + {x}_{M - 1} ( n - {τ}_{M - 1} ) ]}^{2}\end{matrix} \qquad ( 2 )$$

Assuming that only one sound source is present, it can be seen that E is maximal when the delays τₘ are such that the microphone signals are in phase, and therefore add constructively.

A problem with this technique is that energy peaks are very wide [R. Duraiswami, D. Zotkin, and L. Davis, “Active speech source localization by a dual coarse-to-fine search”, in Proceedings IEEE International Conference on Acoustics, Speech, and Signal Processing, 2001, pp. 3309-3312], which means that the resolution is poor. Moreover, in the case where multiple sources are present, it is likely that the two or more energy peaks overlap whereby it becomes impossible to differentiate one peak from the other(s). A method for narrowing the peaks is to whiten the microphone signals prior to calculating the energy [M. Omologo and P. Svaizer, “Acoustic event localization using a crosspower spectrum phase based technique”, in Proceedings IEEE International Conference on Acoustics, Speech, and Signal Processing, 1994, pp. II.273-II.276]. Unfortunately, the coarse-fine search method as proposed in [R. Duraiswami, D. Zotkin, and L. Davis, “Active speech source localization by a dual coarse-to-fine search”, in Proceedings IEEE International Conference on Acoustics, Speech, and Signal Processing, 2001, pp. 3309-3312] cannot be used in that case because the narrow peaks can be missed during the coarse search. Therefore, a full fine search is used and corresponding computer power is required. It is possible to reduce the amount of computation by calculating the output beamformer energy in the frequency domain. This also has the advantage of making the whitening of the signal easier.

For that purpose, the beamformer output energy in Equation 2 can be expanded as:

$$\begin{matrix}E = {\sum }_{m = 0}^{M - 1} {\sum }_{n = 0}^{L - 1} {x}_{m}^{2} ( n - {τ}_{m} ) + \\ 2 {\sum }_{{m}_{1} = 0}^{M - 1} {\sum }_{{m}_{2} = 0}^{{m}_{1} - 1} {\sum }_{n = 0}^{L - 1} {x}_{{m}_{1}} ( n - {τ}_{{m}_{1}} ) {x}_{{m}_{2}} ( n - {τ}_{{m}_{2}} )\end{matrix} \qquad ( 3 )$$

which in turn can be rewritten in terms of cross-correlations:

$$E = K + 2 {\sum }_{{m}_{1} = 0}^{M - 1} {\sum }_{{m}_{2} = 0}^{{m}_{1} - 1} {R}_{{x}_{{m}_{1}} , {x}_{{m}_{2}}} ( {τ}_{{m}_{1}} - {τ}_{{m}_{2}} ) \qquad ( 4 )$$

where

$$K = {\sum }_{m = 0}^{M - 1} {\sum }_{n = 0}^{L - 1} {x}_{m}^{2} ( n - {τ}_{m} )$$

is nearly constant with respect to the τₘ delays and can thus be ignored when maximizing E. The cross-correlation function can be approximated in the frequency domain as:

$${R}_{ij} ( τ ) \approx {\sum }_{k = 0}^{L - 1} {X}_{i} ( k ) {X}_{j} ( k ) * {ⅇ}^{j 2 x k σ / L} \qquad ( 5 )$$

where Xᵢ(k) is the discrete Fourier transform of xᵢ[n],Xᵢ(k)Xⱼ(k)* is the cross-power spectrum of xᵢ[n] and xⱼ[n] and (·)* denotes the complex conjugate.

Operation 22 (FIG. 2)

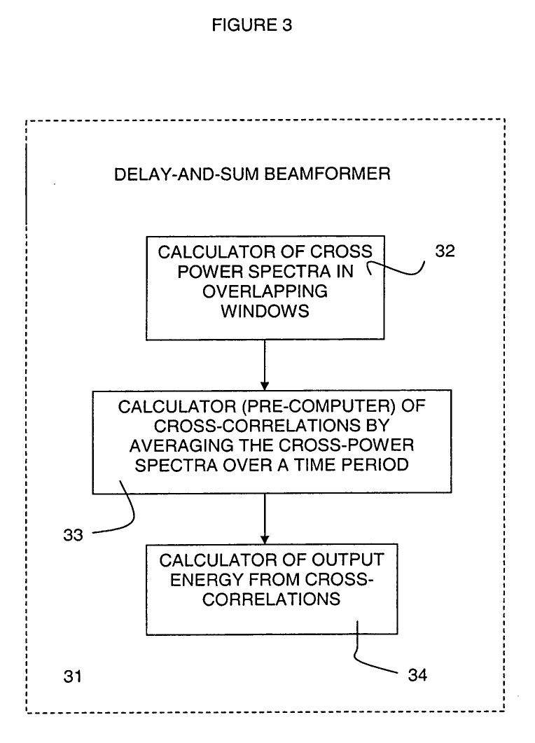

A calculator 32 (FIG. 3) computes the power spectra and cross-power spectra in overlapping windows (50% overlap) of, for example, L=1024 samples at 48 kHz (see operation 22 of FIG. 2 and calculator 32 of FIG. 3).

Operation 23 (FIG. 2)

A calculator 33 (FIG. 3) then computes cross-correlations Rᵢⱼ(τ) by averaging the cross-power spectra Xᵢ(k)Xⱼ(k)* over, for example, a time period of 4 frames (40 ms).

Operation 24 (FIG. 2)

A calculator 34 (FIG. 3) computes the beamformer output energy E from the cross-correlations Rᵢⱼ(τ) (see Equation 4). When the cross-correlations Rᵢⱼ(τ) are pre-computed, it is possible to compute the beamformer output energy E using only M(M−1)/2 lookup and accumulation operations, whereas a time-domain computation would require 2L(M+2) operations. For M=8 and 2562 directions, it follows that the complexity of the search itself is reduced from 1.2 Gflops to only 1.7 Mflops. After counting all time-frequency transformations, the complexity is only 48.4 Mflops, 25 times less than a time domain search with the same resolution.

2.2 Spectral Weighting

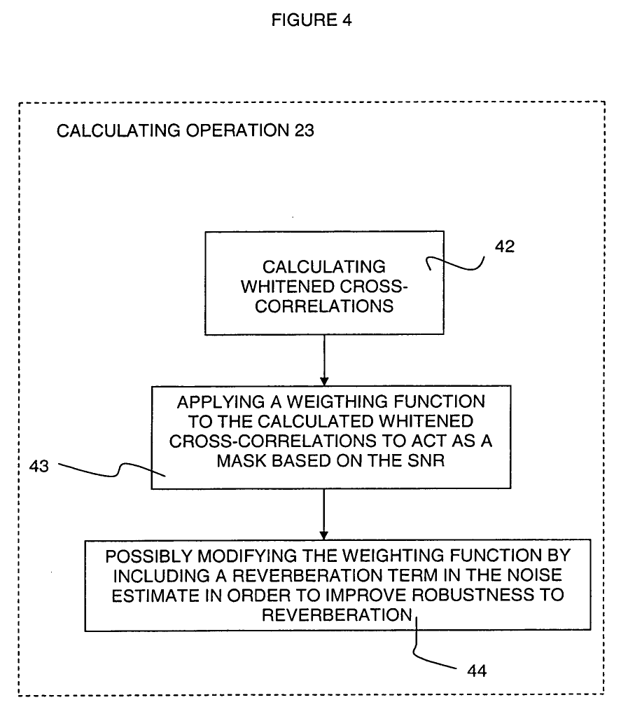

Operation 42 (FIG. 4)

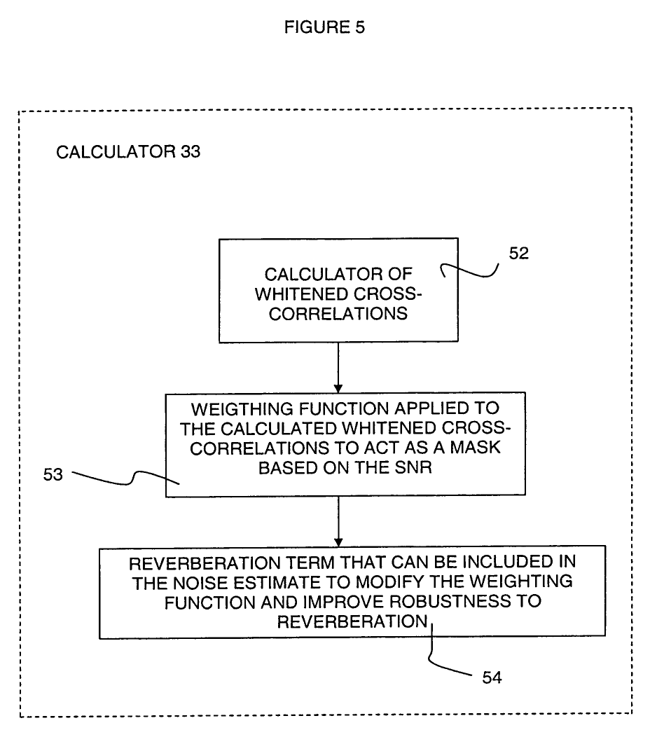

A cross-correlation calculator 52 (FIG. 5) computes, in the frequency domain, whitened cross-correlations using the following expression:

$${R}_{ij}^{( ω )} ( τ ) \approx {\sum }_{k = 0}^{L - 1} \frac{{X}_{i} ( k ) {{X}_{j} ( k )}^{*}}{\vert {X}_{i} ( k ) \vert \vert {X}_{j} ( k ) \vert} {ⅇ}^{j2x k σ / L} \qquad ( 6 )$$

While it produces much sharper cross-correlation peaks, the whitened cross-correlations have one drawback: each frequency bin of the spectrum contributes the same amount to the final correlation, even if the signal at that frequency is dominated by noise. This makes the system less robust to noise, while making detection of voice (which has a narrow bandwidth) more difficult.

Operation 43 (FIG. 4)

In order to alleviate this problem, a weighting function 53 (FIG. 5) is applied to act as a mask based on the signal-to-noise ratio (SNR). For microphone i, this weighting function 53 is defined as:

$${ζ}_{i}^{n} ( k ) = \frac{{ξ}_{i}^{n} ( k )}{{ξ}_{i}^{n} ( k ) + 1} \qquad ( 7 )$$

where ξᵢ^{η}(k) is an estimate of the a priori SNR at the i^{th} microphone, at time frame η, for frequency k. This estimate of the a priori SNR can be computed using the decision-directed approach proposed by Ephraim and Malah [Y. Ephraim and D. Malah, “Speech enhancement using minimum mean-square error short-time spectral amplitude estimator”, IEEE Transactions on Acoustics, Speech and Signal Processing, vol. ASSP-32, no. 6, pp. 1109-1121, 1984]:

$${ξ}_{i}^{n} ( k ) = \frac{{( 1 - {α}_{d} ) [ {ζ}_{i}^{n - 1} ( k ) ]}^{2} {\vert {X}_{i}^{n - 1} ( k ) \vert}^{2} + {α}_{d} {\vert {X}_{i}^{n} ( k ) \vert}^{2}}{{σ}_{i}^{2} ( k )} \qquad ( 8 )$$

where α_{d}=0.1 is an adaptation rate and σᵢ²(k) is a noise estimate for microphone i. It is easy to estimate σᵢ²(k) using the Minima-Controlled Recursive Average (MCRA) technique [I. Cohen and B. Berdugo, “Speech enhancement for non-stationary noise environments”, Signal Processing, vol. 81, no. 2, pp. 2403-2418, 2001], which adapts the noise estimate during periods of low energy.

Operation 44 (FIG. 4)

It is also possible to make the system more robust to reverberation by modifying the weighting function to include a reverberation term Rᵢⁿ(k) 54 (FIG. 5) in the noise estimate. A simple reverberation model with exponential decay is used:
Rᵢⁿ(k)=γRᵢⁿ⁻¹(k)+(1−γ)δ|cζᵢⁿ(k)Xᵢⁿ⁻¹(k)|¹ (9)
where γ represents a reverberation decay for the room and δ is a level of reverberation. In some sense, Equation 9 can be seen as modeling the precedence effect [[J. Huang, N. Ohnishi, and N. Sugie, “Sound localization in reverberant environment based on the model of the precedence effect”, IEEE Transactions on Instrumentation and Measurement, vol. 46, no. 4, pp. 842-846, 1997] and [J. Huang, N. Ohnishi, X. Guo, and N. Sugie, “Echo avoidance in a computational model of the precedence effect”, Speech Communication, vol. 27, no. 3-4, pp. 223-233, 1999]] in order to give less weight to frequency bins where a loud sound was recently present. The resulting enhanced cross-correlation is defined as:

$${R}_{ij}^{( e )} ( τ ) = {\sum }_{k = 0}^{L - 1} \frac{{ζ}_{i} ( k ) {X}_{i} ( k ) {ζ}_{i} ( k ) {{X}_{j} ( k )}^{*}}{\vert {X}_{i} ( k ) \vert \vert {X}_{j} ( k ) \vert} {ⅇ}^{j2x k σ / L} \qquad ( 10 )$$

2.3 Direction Search on a Spherical Grid.

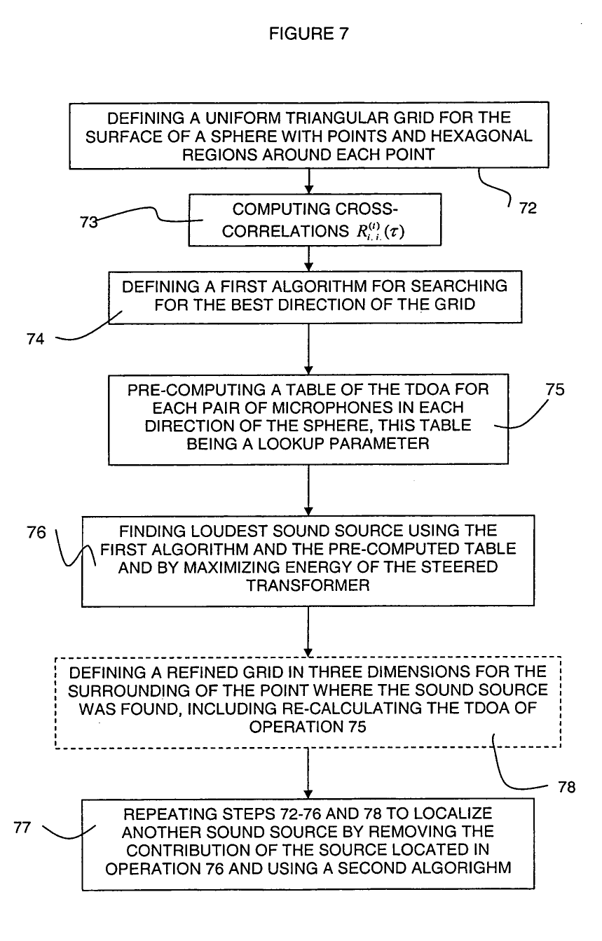

Operation 72 (FIG. 7)

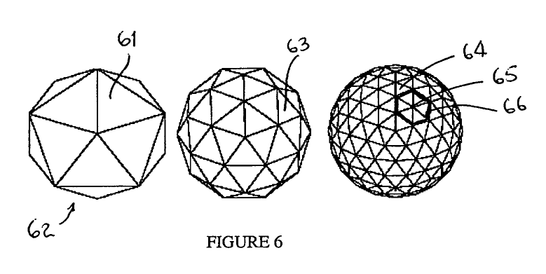

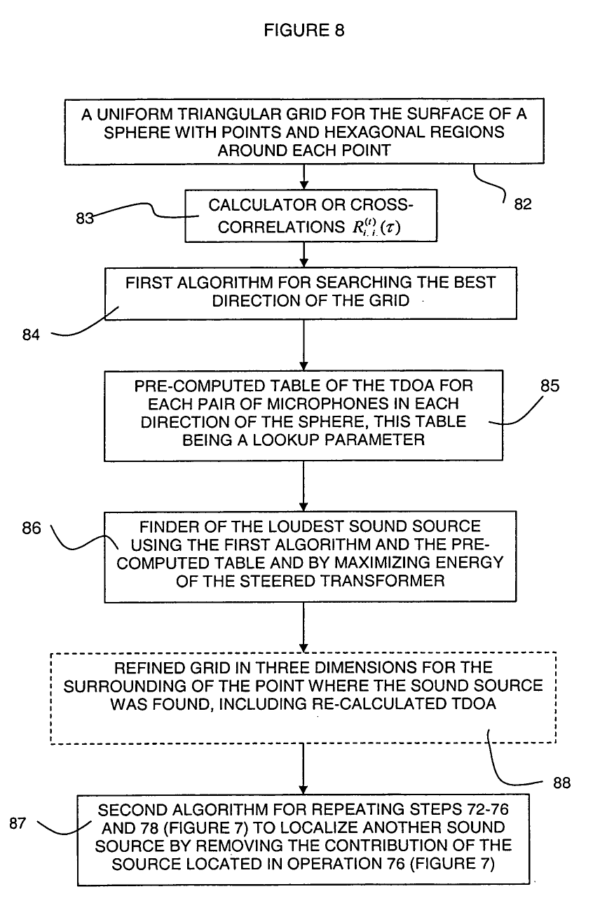

To reduce computation required and make the sound source localization and tracking system isotropic, a uniform triangular grid 82 (FIG. 8) for the surface of a sphere is created to define directions. To create the grid 82, an initial icosahedral grid is used [F. Giraldo, “Lagrange-galerkin methods on spherical geodesic grids”, Journal of Computational Physics, vol. 136, pp. 197-213, 1997]. In the illustrative example of FIG. 6, each triangle such as 61 in an initial 20-element grid 62 is recursively subdivided into four smaller triangles such as 63 and, then, 64. The resulting grid is composed of 5120 triangles such as 64 and 2562 points such as 65. The beamformer energy is then computed for the hexagonal region such as 66 associated with each of these points 65. Each of the 2562 regions 66 covers a radius of about 2.5° around its center, setting the resolution of the search.

Operation 73 (FIG. 7)

A calculator 83 (FIG. 8) computes the cross-correlations Rᵢⱼ^{(e)}(τ) using Equation 10.

Operation 74 (FIG. 7)

In this operation the following Algorithm 1 is defined.

Algorithm 1 Steered beamformer direction search

```
for all grid index d do
    E_{d} [symbol] 0
    for all microphone pair ij do
        τ [symbol] lookup(d,ij)
        E_{d} [symbol] E_{d} + Rᵢⱼ^{(e)} (τ)
    end for
end for
direction of source [symbol] arg max_{d} (E_{d})
```

Once the cross-correlations Rᵢⱼ^{(e)}(τ) are computed, the search for the best direction on the grid can be performed as described by Algorithm 1 (see 84 of FIG. 8).

Operation 75 (FIG. 7)

The lookup parameter of Algorithm 1 is a pre-computed table 85 (FIG. 8) of the TDOA for each pair of microphones and each direction on the grid on the sphere. Using the far-field assumption [J.-M. Valin, F. Michaud, J. Rouat, and D. Letourneau, “Robust sound source localization using a microphone array on a mobile robot”, in Proceedings IEEE/RSJ International Conference on Intelligent Robots and Systems, 2003, pp. 1228-1233], the TDOA in samples is computed as:

$${τ}_{ij} = \frac{{F}_{s}}{c} ( {\vec{p}}_{i} - {\vec{p}}_{j} ) \cdot \vec{u} \qquad ( 11 )$$

where

$${{p}_{i}}^{ρ}$$

is the position of microphone i,

$${u}^{ρ}$$

is a unit-vector that points in the direction of the source, c is the speed of sound and Fₛ is the sampling rate. Equation 11 assumes that the time delay is proportional to the distance between the source and microphone. This is only true when there is no diffraction involved. While this hypothesis is only verified for an “open” array (all microphones are in line of sight with the source), in practice it can be demonstrated experimentally that the approximation is sufficiently good for the sound source localization and tracking system to work for a “closed” array (in which there are obstacles within the array).

For an array of M microphones and an N-element grid, Algorithm 1 requires M(M−1)N table memory accesses and M(M−1)N/2 additions. In the proposed configuration (N=2562, M=8), the accessed data can be made to fit entirely in a modern processor's L2 cache.

Operation 76 (FIG. 7)

A finder 86 (FIG. 1) uses Algorithm 1 and the lookup parameter table 85 to localize the loudest sound source in a certain direction by maximizing the output energy of the steered beamformer.

Operation 77 (FIG. 7)

In order to localize other sound sources that may be present, the process is repeated by removing the contribution of the first source to the cross-correlations, leading to Algorithm 2 (see 87 in FIG. 8). Since the number of sound sources is unknown, the system is designed to look for a predetermined number of sound sources, for example four sources which is then the maximum number of sources the beamformer is able to locate at once. This situation leads to a high rate of false detection, even when four or more sources are present. That problem is handled by the particle filter described in the following description.

Algorithm 2 Localization of multiple sources

```
for q = 1 to assumed number of sources do
    D_{q} [symbol] Steered beamformer direction search
    for all microphone pair ij do
        τ [symbol] lookup(Dₖ,ij)
        Rᵢⱼ^{(e)} (τ) = 0
    end for
end for
```

Operation 78 (FIG. 7)

When a source is located using Algorithm 1, the direction accuracy is limited by the size of the grid being used. It is however possible, as an optional operation, to further refine the source location estimate. For that purpose, a refined grid 88 (FIG. 8) is defined for the surrounding of the point where a sound source was found. To take into account the near-field effects, the grid is refined in three dimensions: horizontally, vertically and over distance. For example, using five points in each direction, a 125-point local grid can be obtained with a maximum error of about 1°. For the near-field case, Equation 11 no longer holds, so it is necessary to compute the TDOA of operation 75 using the following relation:

$${τ}_{ij} = \frac{{F}_{s}}{c} ( ‖ d \vec{u} - {\vec{p}}_{j} ‖ - ‖ d \vec{u} - {\vec{p}}_{i} ‖ ) \qquad ( 12 )$$

where d is the distance between the source and the center of the array. Equation 12 is evaluated for different distances d in order to find the direction of the source with improved accuracy.

3. Particle-Based Tracking

The steered beamformer described hereinabove provides only instantaneous, noisy information about the possible presence and position of sound sources but fails to provide information about the behaviour of the sound source in time (tracking). For that reason, it is desirable to use a probabilistic temporal integration to track different sound sources based on all measurements available up to the current time. Particle filters are an effective way of tracking sound sources. Using this approach, hypotheses about the state of each sound source are represented as a set of particles to which different weights are assigned.

At time t, the case of sources j=0,1, . . . , M−1, each modeled using N particles of positions x_{j,i}^{(t)} and weights ω_{j,i}^{(t)} is considered. The state vector for the particles is composed of six dimensions, three for position and three for its derivative:

$${s}_{j , i}^{( t )} = [ \begin{matrix}{x}_{j , i}^{( t )} \\ {\dot{x}}_{j , i}^{( t )}\end{matrix} ] \qquad ( 13 )$$

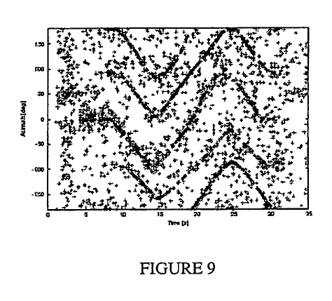

Since the position is constrained to lie on a unit sphere and the speed is tangent to the sphere, there are only four degrees of freedom. The particle filtering outlined in FIG. 9 is generalized to an arbitrary and non-constant number of sources. It does so by maintaining a set of particles for each source being tracked and by computing the assignment between measurements and the sources being tracked. This is different from the approach described in [J. Vermaak, A. Doucet, and P. Pérez, “Maintaining multi-modality through mixture tracking”, in Proceedings International Conference on Computer Vision (ICCV), 2003, pp. 1950-1954] for preserving multi-modality because in the present case each mode has to be a different source.

Algorithm 3 Particle-based tracking algorithm

(1) Predict the state sⱼ^{(t)} from sⱼ^{(t-1)} for each source j
(2) Compute probabilities associated with the steered beamformer response
(3) Compute probabilities P_{q,j}^{(t)} associating beamformer peaks to sources
being tracked
(4) Add or remove sources if necessary
(5) Compute updated particle weights ω_{j,i}^{(t)}
(6) Compute position estimate \overline{x}ⱼ^{(t)} for each source
(7) Resample particles for each source if necessary

3.1 Prediction

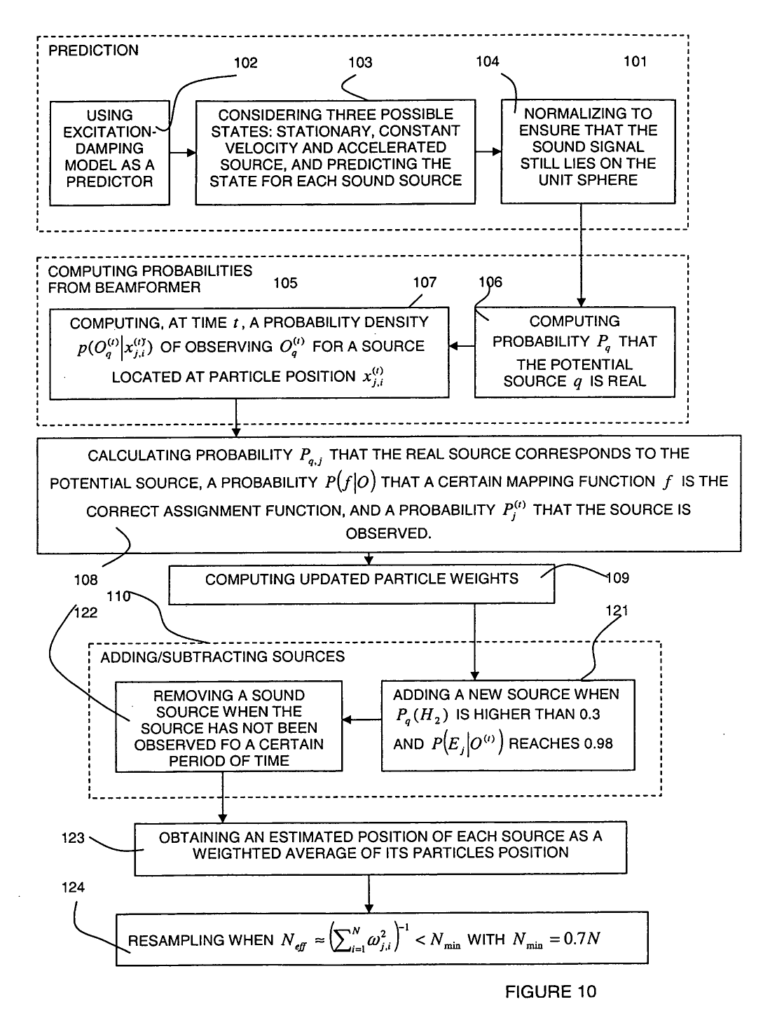

Operation 101 (FIG. 10)

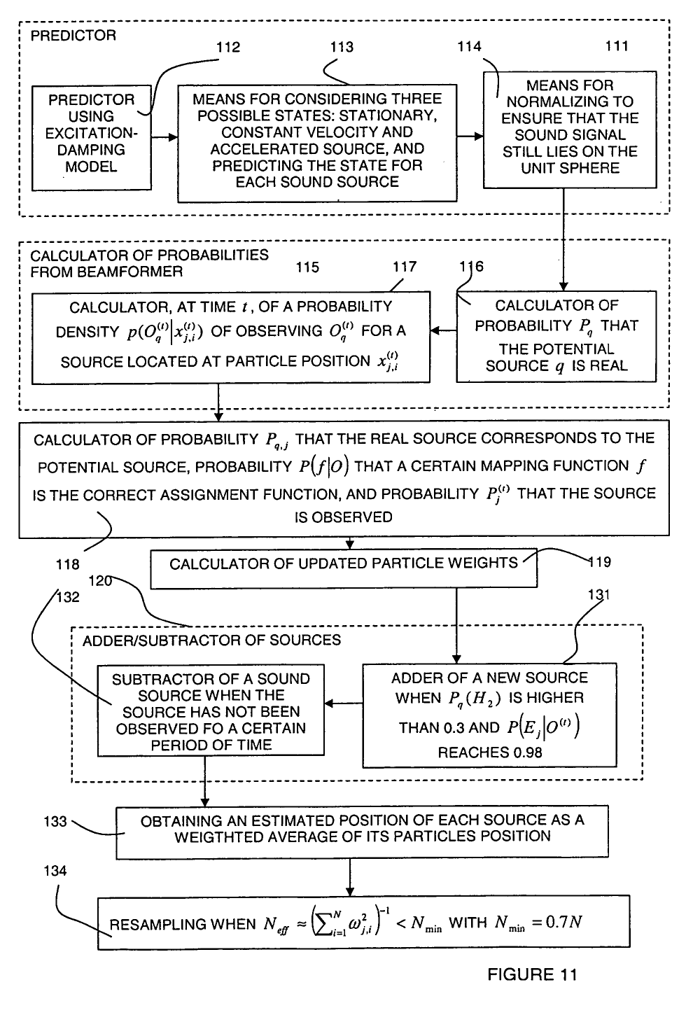

During this operation, the state predictor 111 (FIG. 11) predicts the state sⱼ^{(t)} from the state sⱼ^{(t-1)} for each sound source j.

Operation 102 (FIG. 10)

The excitation-damping model as proposed in [D. B. Ward, E. A. Lehmann, and R. C. Williamson, “Particle filtering algorithms for tracking an acoustic source in a reverberant environment”, IEEE Transactions on Speech and Audio Processing, vol. 11, no. 6, 2003] is used as a predictor 112 (FIG. 11):

$$\begin{matrix}{\dot{x}}_{j , i}^{( t )} = a {\dot{x}}_{j , i}^{( t - 1 )} + {bF}_{x} & ( 14 ) \\ {x}_{j , i}^{( t )} = {x}_{j , i}^{( t - 1 )} + Δ T {\dot{x}}_{j , i}^{( t )} & ( 15 )\end{matrix}$$

where a=e^{-αΔT} controls the damping term, b=β\sqrt{1−a²} controls the excitation term, Fₓ is a normally distributed random variable of unit variance and ΔT is the time interval between updates.

Operation 103 (FIG. 10)

A means 113 (FIG. 11) considers three possible states:
Stationary source (α=2, β=0.04);
Constant velocity source (α=0.05, β=0.2);
Accelerated source (α=0.5, β=0.2).
   and predicts the stationary, constant velocity or accelerated state of the sound source.

Operation 104 (FIG. 10)

A means 114 (FIG. 11) conducts a normalization step to ensure that the particle position xᵢ^{(t)} still lies on the unit sphere (∥x_{j,i}^{(t)}=1) after applying Equations 14 and 15.

3.2 Probabilities from the Beamformer Response

Operation 105 (FIG. 10)

During this operation, the calculator 115 calculates probabilities from the beamformer response.

Operation 106 (FIG. 10)

The above-described steered beamformer produces an observation O^{(t)} for each time t. The observation O^{(t)}=[O₀^{(t)} . . . O_{Q-1}₍ₜ₎] is composed of Q potential source locations y_{q} found by Algorithm 2, as well as the energy E₀ (from Algorithm 1) of the beamformer for the first (most likely) potential source q=0. Denoted O^{(t)} is a set of all observations up to time t.

A calculator 116 (FIG. 11) computes a probability P_{q} that the potential source q is real (not a false detection). The higher the beamformer energy, the more likely a potential source is real. For q>0, false alarms are very frequent and independent of energy. With this in mind, the probability P_{q} is defined empirically as:

$${P}_{q} = \{ \begin{matrix}{v}^{2} / 2 , & q = 0 , v \leq 1 \\ 1 - {v}^{2} / 2 , & q = 0 , v > 1 \\ 0.3 , & q = 1 \\ 0.16 , & q = 2 \\ 0.03 , & q = 3\end{matrix} \qquad ( 16 )$$

with ν=E₀/E_{T}, where E_{T} is a threshold that depends on the number of microphones, the frame size and the analysis window used (for example E_{T}=150 can be used). FIG. 9 shows an example of P_{q} values for four moving sources with azimuth as a function of time.

Operation 107 (FIG. 10)

A calculator 117 (FIG. 11) computes, at time t, a probability density of observing O_{q}^{(t)} for a source located at particle position x_{j,i}^{(t)} using the following relation:
p(O_{q}^{(t)}|x_{j,i}^{(t)})=N(y_{q};x_{j,i};σ²) (17)
where N(y_{q};x_{j,i};σ²) is a normal distribution centered at x_{j,i} with variance σ² and corresponds to the accuracy of the steered beamformer. For example, σ=0.05 is used, which corresponds to a RMS error of 3 degrees for the location found by the steered beamformer.

3.3 Probabilities for Multiple Sources

Operation 108 (FIG. 10)

During this operation, probabilities for multiple sources are calculated.

Before deriving the update rule for the particle weights ω_{j,i}^{(t)}, the concept of source-observation assignment will be introduced. For each potential source q detected by the steered beamformer, there are three possibilities:
It is a false detection (H₀).
It corresponds to one of the sources currently tracked (H₁).
It corresponds to a new source that is not yet being tracked (H₂).

In the case of possibility H₁, it is determined which real source j corresponds to potential source q. First, it is assumed that a potential source may correspond to at most one real source and that a real source can correspond to at most one potential source.

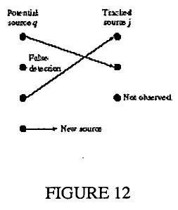

Let ƒ: {0,1, . . . , Q−1}→{−2,−1,0,1, . . . , M−1} be a function assigning observation q to source j (values −2 is used for false detection and −1 is used for a new source). FIG. 12 illustrates a hypothetical case with four potential sources detected by the steered beamformer and their assignment to the real sources. Knowing P(ƒ|O^{(t)}) for all possible ƒ, a calculator 118 computes the probability P_{q,j} that the real source j corresponds to the potential source q using the following expressions:

$$\begin{matrix}{P}_{q , j}^{( t )} = {\sum }_{f} {δ}_{j , f ( q )} P ( f \vert {O}^{( t )} ) & ( 18 ) \\ {P}_{q}^{( t )} ( {H}_{0} ) = {\sum }_{f} {δ}_{- 2 , f ( q )} P ( f \vert {O}^{( t )} ) & ( 19 ) \\ {P}_{q}^{( t )} ( {H}_{2} ) = {\sum }_{f} {δ}_{- 1 , f ( q )} P ( f \vert {O}^{( t )} ) & ( 20 )\end{matrix}$$

where δ_{i,j} is the Kronecker delta.

Omitting t for clarity, the calculator 118 also computes the probability P(ƒ|O) that a certain mapping function ƒ is the correct assignment function using the following relation:

$$P ( f \vert O ) = \frac{p ( O \vert f ) P ( f )}{p ( O )} \qquad ( 21 )$$

Knowing that Σ_{ƒ} P(71 |O)=1, computing the denominator p(O) can be avoided by using normalization. Assuming conditional independence of the observations given the mapping function, we obtain:

$$p ( O \vert f ) = {\prod }_{q} p ( {O}_{q} \vert f ( q ) ) \qquad ( 22 )$$

It is assumed that the distributions of the false detections (H₀) and the new sources (H₂) are uniform, while the distribution for:

$$p ( {O}_{q} \vert f ( q ) ) = \{ \begin{matrix}1 / 4 π , & f ( q ) = - 2 \\ 1 / 4 π , & f ( q ) = - 1 \\ {\sum }_{i} {w}_{f ( q ) , i} p ( O \vert {x}_{j , i} ) , & f ( q ) > 0\end{matrix} \qquad ( 23 )$$

The a priori probability of the function ƒ being the correct assignment is also assumed to come from independent individual components, so that:

$$P ( f ) = {\prod }_{q} P ( f ( q ) ) \qquad ( 24 )$$

with

$$P ( f ( q ) ) = \{ \begin{matrix}( 1 - {P}_{q} ) {P}_{false} , & f ( q ) = - 2 \\ {P}_{q} {P}_{new} & f ( q ) = - 1 \\ {P}_{q} P ( {Obs}_{j}^{( t )} \vert {O}^{( t - 1 )} ) & f ( q ) \geq 0\end{matrix} \qquad ( 25 )$$

Where P_{new} is the a priori probability that a new source appears and P_{false} is the a priori probability of false detection. The probability P(Obsⱼ^{(t)}|O^{(t-1)}) that source j is observable (i.e., that it exists and is active) at time t is given by the following relation:
P(Obsⱼ^{(t)}|O^{(t-1)})=P(Eⱼ|O^{(t-1)})P(Aⱼ^{(t)}|O^{(t-1)}) (26)
where Eⱼ is the event that source j actually exists and Aⱼ^{(t)} is the event that it is active (but not necessarily detected) at time t. By active, it is meant that the signal it emits is non-zero (for example, a speaker who is not making a pause). The probability that the sound source exists using the relation is given by:

$$P ( {E}_{j} \vert {O}^{( t - 1 )} ) = {P}_{j}^{( t - 1 )} + ( 1 - {P}_{j}^{( t - 1 )} ) \frac{{P}_{o} P ( {E}_{j} \vert {O}^{( t - 2 )} )}{1 - ( 1 - {P}_{o} ) P ( {E}_{j} \vert {O}^{( t - 2 )} )} \qquad ( 27 )$$

where P₀ is the a priori probability that a source is not observed (i.e., undetected by the steered beamformer) even if it exists (for example with P₀=0.2 in the present case). Pⱼ^{(t)}=Σ_{q}P_{q,j}^{(t)} is computed by the calculator 118 and represents the probability that source j is observed at time t (assigned to any of the potential sources).

Assuming a first order Markov process, the following relation about the probability of source activity can be written:

$$\begin{matrix}P ( {A}_{j}^{( t )} \vert {O}^{( t - 1 )} ) = P ( {A}_{j}^{( t )} \vert {A}_{j}^{( t - 1 )} ) P ( {A}_{j}^{( t - 1 )} \vert {O}^{( t - 1 )} ) + \\ P ( {A}_{j}^{( t )} \vert ⫬ {A}_{j}^{( t - 1 )} ) [ 1 - P ( {A}_{j}^{( t - 1 )} \vert {O}^{( t - 1 )} ) ]\end{matrix} \qquad ( 28 )$$

with P(Aⱼ^{(t)}|Aⱼ^{(t-1)}) the probability that an active source remains active (for example set to 0.95), and P(Aⱼ^{(t)}| [symbol] Aⱼ^{(t-1)}) the probability that an inactive source becomes active again (for example set to 0.05). Assuming that the active and inactive states are equiprobable, the activity probability is computed using Bayes' rule:

$$P ( {A}_{j}^{( t )} \vert {O}^{( t )} ) = \frac{1}{1 + \frac{[ 1 - P ( {A}_{j}^{( t )} \vert {O}^{( t - 1 )} ) ] [ 1 - P ( {A}_{j}^{( t )} \vert {O}^{( t )} ) ]}{P ( {A}_{j}^{( t )} \vert {O}^{( t - 1 )} ) P ( {A}_{j}^{( t )} \vert {O}^{( t )} )}} \qquad ( 29 )$$

3.4 Weight Update

Operation 109 (FIG. 10)

A calculator 119 (FIG. 11) computes updated particle weights ω_{j,i}^{(t)}.

At times t, the new particle weights for source j are defined as:
ω_{j,i}^{(t)}=p(x_{j,i}^{(t)}|O^{(t)} (30)
Assuming that the observations are conditionally independent given the source position, and knowing that for a given source jΣᵢ₌₁^{N}ω_{j,i}^{(t)}=1, it can be obtained through Bayesian inference:

$$\begin{matrix}{ω}_{j , i}^{( t )} = \frac{p ( {O}^{( t )} \vert {x}_{j , i}^{( t )} ) p ( {x}_{j , i}^{( t )} )}{p ( {O}^{( t )} )} \\ = \frac{p ( {O}^{( t )} \vert {x}_{j , i}^{( t )} ) p ( {O}^{( t - 1 )} \vert {x}_{j , i}^{( t )} ) p ( {x}_{j , i}^{( t )} )}{p ( {O}^{( t )} )} \\ = \frac{p ( {x}_{j , i} \vert {O}^{( t )} ) p ( {x}_{j , i}^{( t )} \vert {O}^{( t - 1 )} ) p ( {O}^{( t )} ) p ( {O}^{( t - 1 )} )}{p ( {O}^{( t )} ) p ( {x}_{j , i}^{( t )} )} \\ = \frac{p ( {x}_{j , i}^{( t )} \vert {O}^{( t )} ) {ω}_{j , i}^{( t - 1 )}}{{\sum }_{i = 1}^{N} p ( {x}_{j , i}^{( t )} \vert {O}^{( t )} ) {ω}_{j , i}^{( t - 1 )}}\end{matrix} \qquad ( 31 )$$

Let Iⱼ^{(t)} denote the event that source j is observed at time t and knowing that P(Iⱼ^{(t)})=Pⱼ^{(t)}=Σ_{q}P_{q,j}^{(t)}, we obtain:
p(x_{j,i}^{(t)}|O^{(t)})=(1−Pⱼ^{(t)})p(x_{j,i}^{(t)}|O^{(t)},Iⱼ^{(t)})+Pⱼ^{(t)}p(x_{j,i}^{(t)}|O^{(t)}, Iⱼ^{(t)}) (32)
In the case where no observation matches the source, all particle positions have the same probability to be observed, so we obtain:

$$\begin{matrix}p ( {x}_{j , i}^{( t )} \vert {O}^{( t )} ) = ( 1 - {P}_{j}^{( t )} ) \frac{1}{N} + \\ {P}_{j} \frac{{\sum }_{q = 1}^{Q} {P}_{q , j}^{( t )} p ( {O}_{q}^{( t )} \vert {x}_{j , i}^{( t )} )}{{\sum }_{i = 1}^{N} {\sum }_{q = 1}^{Q} {P}_{q , j}^{( t )} p ( {O}_{q}^{( t )} \vert {x}_{j , i}^{( t )} )}\end{matrix} \qquad ( 33 )$$

where the denominator on the right side of Equation 33 ensures that Σᵢ₌₁^{N}p(x_{j,i}^{(t)}|O^{(t)}, Iⱼ^{(t)})=1.

3.5 Adding or Removing Sources

Operation 110 (FIG. 10)

During this operation, an adder/subractor adds or removes sound sources.

Operation 121 (FIG. 10)

In a real environment, sources may appear or disappear at any moment. If, at any time, P_{q}(H₂) is higher than a threshold set, for example, to 0.3, it is considered that a new source is present. The adder 131 (FIG. 11) then adds a new source, and a set of particles is created for source q. Even when a new source is created, it is only assumed to exist if its probability of existence P(Eⱼ|O^{(t)}) reaches a certain threshold, which is set, for example, to 0.98.

Operation 122 (FIG. 10)

In the same manner, a time limit is set on sources. If the source has not been observed (Pⱼ^{(t)}<T_{obs}) for a certain period of time, it is considered that it no longer exists and the subtractor 132 (FIG. 11) removes this source. In that case, the corresponding particle filter is no longer updated nor considered in future calculations.

3.6 Parameter Estimation

Operation 123 (FIG. 10)

Parameter estimation is conducted during this operation.

More specifically, a parameter estimator 133 obtains an estimated position of each source as a weighted average of the positions of its particles:

$${\overline{x}}_{j}^{( t )} = {\sum }_{i = 1}^{N} {ω}_{j , i}^{( t )} {x}_{j , i}^{( t )} \qquad ( 34 )$$

It is however possible to obtain better accuracy simply by adding a delay to the algorithm. This can be achieved by augmenting the state vector by past position values. At time t, the position at time t−T is thus expressed as:

$${\overline{x}}_{j}^{( t - T )} = {\sum }_{i = 1}^{N} {ω}_{j , i}^{( t )} {x}_{j , i}^{( t - T )} \qquad ( 35 )$$

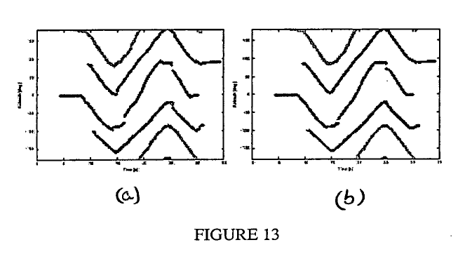

Using the same example as in FIG. 9, FIG. 13 shows how the particle filter is capable of removing the noise and produce smooth trajectories. The added delay produces an even smoother result.

3.7 Resampling

Operation 124 (FIG. 10)

Resampling is performed by a resampler 134 (FIG. 10) only when

$${N}_{eff} \approx {( {\sum }_{i = 1}^{N} {ω}_{j , i}^{2} )}^{- 1} < {N}_{min}$$

[A. Doucet, S. Godsill, and C. Andrieu, “On sequential Monte Carlo sampling methods for bayesian filtering”, Statistics and Computing, vol. 10, pp. 197-208, 2000] with Nₘᵢₙ=0.7N. That criterion ensures that resampling only occurs when new data is available for a certain source. Otherwise, this would cause unnecessary reduction in particle diversity, due to some particles randomly disappearing.

4. Results

The proposed sound source localization and tracking method and system were tested using an array of omni-directional microphones, each composed of an electret cartridge mounted on a simple pre-amplifier. The array was composed of eight microphones since this is the maximum number of analog input channels on commercially available soundcards; of course, it is within the scope of the present invention to use a number of microphones different from eight (8). Two array configurations were used for the evaluation of the sound source localization and tracking method and system. The first configuration (C1) was an open array and included inexpensive microphones arranged on the summits of a 16 cm cube mounted on top of the Spartacus robot (not shown). The second configuration (C2) was a closed array and uses smaller, middle-range cost microphones, placed through holes at different locations on the body of the robot. For both arrays, all channels were sampled simultaneously using a RME Hammerfall Multiface DSP connected to a laptop computer through a CardBus interface. Running the sound source localization and tracking system in real-time currently required 25% of a 1.6 GHz Pentium-M CPU. Due to the low complexity of the particle filtering algorithm, it was possible to use 1000 particles per source without any noticeable increase in complexity. This also means that the CPU time cost does not increase significantly with the number of sources present. For all tasks, configurations and environments, all parameters had the same value, except for the reverberation decay, which was set to 0.65 in the E1 environment and 0.85 in the E2 environment.

Experiments were conducted in two different environments. The first environment (E1) was a medium-size room (10 m×11 m, 2.5 m ceiling) with a reverberation time (−60 dB) of 350 ms. The second environment (E2) was a hall (16 m×17 m, 3.1 m ceiling, connected to other rooms) with 1.0 s reverberation time.

4.1 Characterization

The system was characterized in environment E1 in terms of detection reliability and accuracy. Detection reliability is defined as the capacity to detect and localize sounds within 10 degrees, while accuracy is defined as the localization error for sources that are detected. Three different types of sound were used: a hand clap, the test sentence “Spartacus, come here”, and a burst of white noise lasting 100 ms. The sounds were played from a speaker placed at different locations around the robot and at three different heights: 0.1 m, 1 m, 1.4 m.

4.1.1 Detection Reliability

Detection reliability was tested at distances (measured from the center of the array) ranging from 1 m (a normal distance for close interaction) to 7 m (limitations of the room). Three indicators were computed: correct localization (within 10 degrees), reflections (incorrect elevation due to roof of ceiling), and other errors. For all indicators, the number of occurrences divided by the number of sounds played was computed. This test included 1440 sounds at a 22.5° interval for 1 m and 3 m and 360 sounds at a 90° interval for 5 m and 7 m.

Results are shown in Table 1 for both C1 and C2 configurations. In configuration C1, results show near-perfect reliability even at seven meter distance. For C2, reliability depends on the sound type, so detailed results for different sounds are provided in Table 2.

Like most localization algorithms, the sound source localization and tracking method and system was unable to detect pure tones. This behavior is explained by the fact that sinusoids occupy only a very small region of the spectrum and thus have a very small contribution to the cross-correlations with the proposed weighting. It must be noted that tones tend to be more difficult to localize even for the human auditory system.

TABLE 1
Detection reliability for C1 and C2 configurations

| | Correct (%) | | Reflection (%) | | Other error (%) | |
|---|---|---|---|---|---|---|
| Distance | C1 | C2 | C1 | C2 | C1 | C2 |
| 1 m | 100 | 94.2 | 0.0 | 7.3 | 0.0 | 1.3 |
| 3 m | 99.4 | 80.6 | 0.0 | 21.0 | 0.3 | 0.1 |
| 3 m | 98.3 | 89.4 | 0.0 | 0.0 | 0.0 | 1.1 |
| 7 m | 100 | 85.0 | 0.6 | 1.1 | 0.6 | 1.1 |

TABLE 2
Correct localization rate as a function of sound type
and distance for C2 configuration

| Distance | Hand clap (%) | Speech (%) | Noise burst (%) |
|---|---|---|---|
| 1 m | 88.3 | 98.3 | 95.8 |
| 3 m | 50.8 | 97.9 | 92.9 |
| 5 m | 71.7 | 98.3 | 98.3 |
| 7 m | 61.7 | 95.0 | 98.3 |

4.1.2 Localization Accuracy

In order to measure the accuracy of the sound source localization and tracking method and system, the same setup as for measuring reliability was used, with the exception that only distances of 1 m and 3m were tested (1440 sounds at a 22.5° interval) due to the limited space available in the testing environment. Neither distance nor sound type has significant impact on accuracy. The root mean square accuracy results are shown in Table 3 for configurations C1 and C2. Both azimuth and elevation are shown separately. According to [W. M. Hartmann, “Localization of sounds in rooms”, Journal of the Acoustical Society of America, vol. 74, pp. 1380-1391, 1983] and [B. Rakerd and W. M. Hartmann, “Localization of noise in a reverberant environment”, in Proceedings 18th International Congress on Acoustics, 2004], human sound localization accuracy ranges between two and four degrees in similar conditions. The localization accuracy of the sound source localization and tracking method and system is thus equivalent or better than human localization accuracy.

TABLE 3
Localization accuracy (root mean square error)

| Localization error | C1 (deg) | C2 (deg) |
|---|---|---|
| Azimuth | 1.10 | 1.44 |
| Elevation | 0.89 | 1.41 |

4.2 Source Tracking

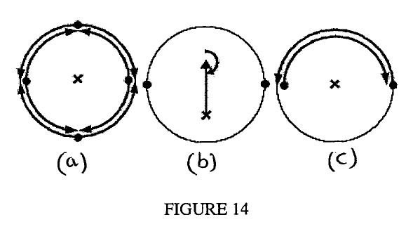

The tracking capabilities of the sound source localization and tracking method and system for multiple sound sources were measured. These measurements were performed using the C2 configuration in both E1 and E2 environments. In all cases, the distance between the robot and the sources was approximately two meters. The azimuth is shown as a function of time for each source. The elevation is not shown as it is almost the same for all sources during these tests. The trajectories for the three experiments are shown in FIGS. 14a, 14b and 14c.

4.2.1 Moving Sources

In a first experiment, four people were told to talk continuously (reading a text with normal pauses between words) to the robot while moving, as shown in FIG. 14a. Each person walked 90 degrees towards the left of the robot before walking 180 degrees towards the right.

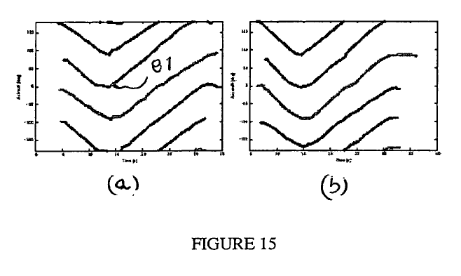

Results are presented in FIG. 15 for delayed estimation (500 ms). In both environments, the source estimated trajectories are consistent with the trajectories of the four speakers.

4.2.2 Moving Robot

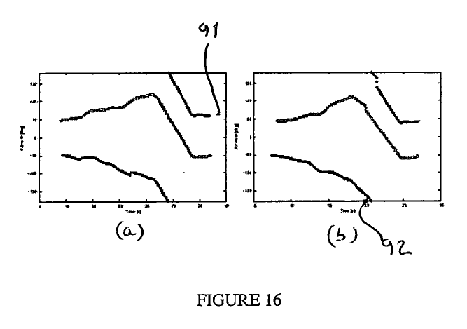

Tracking capabilities of the sound source localization and tracking method and system were also evaluated in the context where the robot is moving, as shown in FIG. 14b. In this experiment, two people are talking continuously to the robot as it is passing between them. The robot then makes a half-turn to the left. Results are presented in FIG. 16 for delayed estimation (500 ms). Once again, the estimated source trajectories are consistent with the trajectories of the sources relative to the robot for both environments.

4.2.3 Sources with Intersecting Trajectories

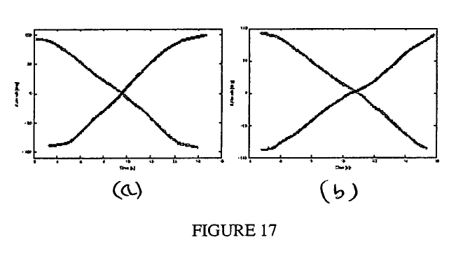

In this experiment, two moving speakers are talking continuously to the robot, as shown in FIG. 14c. They start from each side of the robot, intersecting in front of the robot before reaching the other side. Results in FIG. 17 show that the particle filter is able to keep track of each source. This result is possible because the prediction step imposes some inertia to the sources.

4.2.4 Number of Microphones

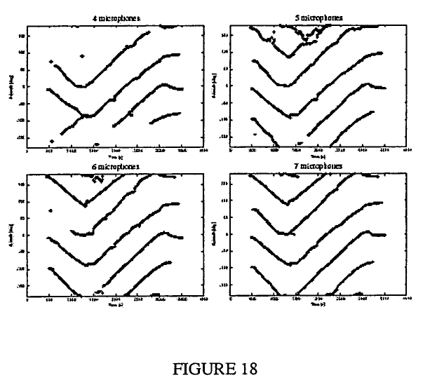

These results evaluate how the number of microphones affects the system capabilities. For that purpose, the same recording as in 4.2.1 for C2 in E1 with only a subset of the microphone signals to perform localization. Since a minimum of four microphones are necessary for localizing sounds without ambiguity, the sound source localization and tracking method and system were evaluated using four to seven microphones (selected arbitrarily as microphones number 1 through N). Comparing results from FIG. 18 to those obtained in FIG. 15 for E1, it can be observed that tracking capabilities degrade as microphones are removed. While using seven microphones makes little difference compared to the baseline of eight microphones, the system was unable to reliably track more than two of the sources when only four microphones were used. Although there is no theoretical relationship between the number of microphones and the maximum number of sources that can be tracked, this clearly shows how the redundancy added by using more microphones can help in the context of sound source localization and tracking.

4.3 Localization and Tracking for Robot Control

This experiment is performed in real-time and consists of making the robot follow the person speaking to it. At any time, only the source present for the longest time is considered. When the source is detected in front (within 10 degrees) of the robot, it moves forward. At the same time, regardless of the angle, the robot turns toward the source in such a way as to keep the source in front. Using this simple control system, it is possible to control the robot simply by talking to it, even in noisy and reverberant environments. This has been tested by controlling the robot going from environment E1 to environment E2, having to go through corridors and an elevator, speaking to the robot with normal intensity at a distance ranging from one meter to two meters. The system worked in real-time, providing tracking data at a rate of 25 Hz (no delay on the estimator) with the reaction time dominated by the inertia of the robot.

Using an array of eight microphones, the system was able to localize and track simultaneous moving sound sources in the presence of noise and reverberation, at distances up to seven meters. It has been demonstrated that the system is capable of controlling in real-time the motion of a robot, using only the direction of sounds. It was demonstrated that the combination of a frequency-domain steered beamformer and a particle filter has multiple source tracking capabilities. Moreover, the proposed solution regarding the source-observation assignment problem is also applicable to other multiple object tracking problems.

A robot using the proposed sound source localization and tracking method and system has access to a rich, robust and useful set of information derived from its acoustic environment. This can certainly affect its ability of making autonomous decisions in real life settings, and showing higher intelligent behaviour. Also, because the system is able to localize multiple sound sources, it can be exploited by a sound-separating algorithm and enables speech recognition to be performed. This enables identification of the localized sound sources so that additional relevant information can be obtained from the acoustic environment.

Although the present invention has been described hereinabove with reference to an illustrative embodiment thereof, this embodiment can be modified at will, within the scope of the appended claims, without departing from the spirit and nature of the present invention.

What is claimed is:

1. A system for localizing and tracking a plurality of sound sources, comprising:
a set of spatially spaced apart sound sensors to detect sound from the sound sources and produce corresponding sound signals;
a sound source detector responsive to the sound signals from the sound sensors and steered in a range of directions to localize the sound sources; and
a particle filtering tracker connected to the sound source detector for simultaneously tracking the plurality of sound sources.

2. A sound source localizing and tracking system as defined in claim 1, wherein the set of sound sensors comprises a predetermined number of omnidirectional microphones arranged in a predetermined array.

3. A sound source localizing and tracking system as defined in claim 1, wherein the sound source detector is a frequency-domain steered beamformer.

4. A sound source localizing and tracking system as defined in claim 3, wherein the steered beamformer comprises:
a calculator of sound power spectra and cross-power spectra of sound signal samples in overlapping windows;
a calculator of cross-correlations by averaging the cross-power spectra over a given period of time;
a calculator of an output energy of the steered beamformer from the calculated cross-correlations; and
a finder of a loudest sound source localized in a given direction, the given direction of the loudest sound source being found by maximizing the output energy of the steered beamformer.

5. A sound source localizing and tracking system as defined in claim 4, wherein the calculator of cross-correlations comprises:
a calculator for computing, in the frequency domain, whitened cross-correlations; and
a weighting function applied to the calculated whitened cross-correlations to act as a mask based on a signal-to-noise ratio.

6. A sound source localizing and tracking system as defined in claim 5, wherein the weighting function is modified to include a reverberation term in a noise estimate in order to make the system more robust to reverberation.

7. A sound source localizing and tracking system as defined in claim 3, wherein the steered beamformer produces an output energy and comprises:
a uniform triangular grid for the surface of a sphere to define directions;
a calculator of sound power spectra and cross-power spectra of sound signal samples in overlapping windows;
a calculator of cross-correlations by averaging the cross-power spectra over a given period of time;
a first algorithm for searching a best direction on the grid of the sphere;
a pre-computed table of time delays of arrival for each pair of sound sensors and each direction on the grid of the sphere; and
a finder of a loudest sound source in a direction of the grid of the sphere, the direction of the loudest sound source being found using the first algorithm and the pre-computed table by maximizing the output energy of the steered beamformer.

8. A sound source localizing and tracking system as defined in claim 7, further comprising a second algorithm for finding another sound source after having removed the contribution of the loudest sound source located by the finder.

9. A sound source localizing and tracking system as defined in claim 7, wherein the steered beamformer further comprises:
a refined grid for the surrounding of a point where a sound source was found in order to find a direction of localization of the found sound source with improved accuracy.

10. A sound source localizing and tracking system as defined in claim 1, wherein the particle filtering tracker models each sound source using a number of particles having respective directions and weights.

11. A sound source localizing and tracking system as defined in claim 1, wherein the particle filtering tracker comprises:
a calculator of a probability that a potential source is a real source.

12. A sound source localizing and tracking system as defined in claim 1, wherein the particle filtering tracker comprises:
a calculator of a probability that a real source corresponds to a potential source detected by the sound source detector.

13. A sound source localizing and tracking system as defined in claim 10, wherein the particle filtering tracker comprises:
a calculator of (a) at least one of a probability that a sound source is observed and a probability that a real sound source corresponds to a potential sound source, and (b) a probability density of observing a sound source at a given particle position; and
a calculator of updated particle weights in response to said probability density and said at least one probability.

14. A sound source localizing and tracking system as defined in claim 1, wherein the particle filtering tracker comprises:
an adder of a new source when a probability that the new source is real is higher than a first threshold.

15. A sound source localizing and tracking system as defined in claim 14, wherein the sound source localizing and tracking system assumes that the added new source exists if a probability of existence of said new source reaches a second threshold.

16. A sound source localizing and tracking system as defined in claim 1, wherein the particle filtering tracker comprises:
a subtractor of a source when the latter source has not been observed for a certain period of time.

17. A sound source localizing and tracking system as defined in claim 13, wherein the particle filtering tracker comprises:
an estimator of a position of each source as a weighted average of the positions of its particles, said estimator being responsive to the calculated, updated particle weights.

18. A system for localizing at least one sound source, comprising:
a set of spatially spaced apart sound sensors to detect sound from said at least one sound source and produce corresponding sound signals; and
a frequency-domain beamformer responsive to the sound signals from the sound sensors and steered in a range of directions to localize, in a single step, said at least one sound source.

19. A sound source localizing system as defined in claim 18, wherein the set of sound sensors comprises a predetermined number of omnidirectional microphones arranged in a predetermined array.

20. A sound source localizing system as defined in claim 18, wherein the steered beamformer comprises:
a calculator of sound power spectra and cross-power spectra of sound signal samples in overlapping windows;
a calculator of cross-correlations by averaging the cross-power spectra over a given period of time;
a calculator of an output energy of the steered beamformer from the calculated cross-correlations; and
a finder of a loudest sound source localized in a given direction, the given direction of the loudest sound source being found by maximizing the output energy of the steered beamformer.

21. A sound source localizing system as defined in claim 20, wherein the calculator of cross-correlations comprises:
a calculator for computing, in the frequency domain, whitened cross-correlations; and
a weighting function applied to the calculated whitened cross-correlations to act as a mask based on a signal-to-noise ratio.

22. A sound source localizing system as defined in claim 21, wherein the weighting function is modified to include a reverberation term in a noise estimate in order to make the system more robust to reverberation.

23. A sound source localizing and tracking system as defined in claim 18, wherein the steered beamformer produces an output energy and comprises:
a uniform triangular grid for the surface of a sphere to define directions;
a calculator of sound power spectra and cross-power spectra of sound signal samples in overlapping windows;
a calculator of cross-correlations by averaging the cross-power spectra over a given period of time;
a first algorithm for searching a best direction on the grid of the sphere;
a pre-computed table of time delays of arrival for each pair of sound sensors and each direction on the grid of the sphere; and
a finder of a loudest sound source in a direction of the grid of the sphere, the direction of the loudest sound source being found using the first algorithm and the pre-computed table by maximizing the output energy of the steered beamformer.

24. A sound source localizing system as defined in claim 23, further comprising a second algorithm for finding another sound source after having removed the contribution of the loudest sound source located by the finder.

25. A sound source localizing and tracking system as defined in claim 23, wherein the steered beamformer further comprises:
a refined grid for the surrounding of a point where a sound source was found in order to find a direction of localization of the found sound source with improved accuracy.

26. A system for tracking a plurality of sound sources, comprising:
a set of spatially spaced apart sound sensors to detect sound from the sound sources and produce corresponding sound signals; and
a sound source particle filtering tracker responsive to the sound signals from the sound sensors for simultaneously tracking the plurality of sound sources.

27. A sound source tracking system as defined in claim 26, wherein the particle filtering tracker models each sound source using a number of particles having respective directions and weights.

28. A sound source tracking system as defined in claim 26, wherein the particle filtering tracker comprises:
a calculator of a probability that a potential source is a real source.

29. A sound source tracking system as defined in claim 26, wherein the particle filtering tracker comprises:
a calculator of a probability that a real source corresponds to a potential source.

30. A sound source tracking system as defined in claim 27, wherein the particle filtering tracker comprises:
a calculator of (a) at least one of a probability that a sound source is observed and a probability that a real sound source corresponds to a potential sound source, and (b) a probability density of observing a sound source at a given particle position; and
a calculator of updated particle weights in response to said probability density and said at least one probability.

31. A sound source tracking system as defined in claim 26, wherein the particle filtering tracker comprises:
an adder of a new source when a probability that the new source is real is higher than a first threshold.

32. A sound source tracking system as defined in claim 31, wherein the sound source tracking system assumes that the added new source exists if a probability of existence of said new source reaches a second threshold.

33. A sound source tracking system as defined in claim 26, wherein the particle filtering tracker comprises:
a subtractor of a source when the latter source has not been observed for a certain period of time.

34. A sound source tracking system as defined in claim 30, wherein the particle filtering tracker comprises:
an estimator of a position of each source as a weighted average of the positions of its particles, said estimator being responsive to the calculated, updated particle weights.

35. A method for localizing and tracking a plurality of sound sources, comprising:
detecting sound from the sound sources through a set of spatially spaced apart sound sensors to produce corresponding sound signals;
localizing the sound sources in response to the sound signals, localizing the sound sources including steering in a range of directions a sound source detector having an output; and
simultaneously tracking the plurality of sound sources, using particle filtering, in relation to the output from the sound source detector.

36. A sound source localizing and tracking method as defined in claim 35, wherein steering a sound source detector comprises steering a frequency-domain beamformer.

37. A sound source localizing and tracking method as defined in claim 36, wherein localizing the sound sources comprises:
computing sound power spectra and cross-power spectra of sound signal samples in overlapping windows;
computing cross-correlations by averaging the cross-power spectra over a given period of time;
computing an output energy of the steered beamformer from the calculated cross-correlations; and
finding a loudest sound source localized in a given direction, the given direction of the loudest sound source being found by maximizing the output energy of the steered beamformer.

38. A sound source localizing and tracking method as defined in claim 37, wherein computing the cross-correlations comprises:
computing, in the frequency domain, whitened cross-correlations; and
applying a weighting function to the computed whitened cross-correlations to act as a mask based on a signal-to-noise ratio.

39. A sound source localizing and tracking method as defined in claim 38, comprising modifying the weighting function by including a reverberation term in a noise estimate in order to make the method more robust to reverberation.

40. A sound source localizing and tracking method as defined in claim 36, wherein localizing the sound sources comprises:
defining a uniform triangular grid for the surface of a sphere to define directions;
computing sound power spectra and cross-power spectra of sound signal samples in overlapping windows;
computing cross-correlations by averaging the cross-power spectra over a given period of time;
pre-computing a table of time delays of arrival for each pair of sound sensors and each direction on the grid of the sphere; and
finding a loudest sound source in a direction of the grid of the sphere, finding the loudest sound source comprising searching a best direction on the grid of the sphere using a first algorithm and the pre-computed table by maximizing an output energy of the steered beamformer.

41. A sound source localizing and tracking method as defined in claim 40, comprising finding another sound source, using a second algorithm, after having removed the contribution of the located, loudest sound source.

42. A sound source localizing and tracking method as defined in claim 40, wherein localizing the sound sources further comprises:
defining a refined grid for the surrounding of a point where a sound source was found in order to find a direction of localization of the found sound source with improved accuracy.

43. A sound source localizing and tracking method as defined in claim 35, wherein simultaneously tracking the plurality of sound sources, using particle filtering, comprises modeling each sound source using a number of particles having respective directions and weights.

44. A sound source localizing and tracking method as defined in claim 35, wherein simultaneously tracking the plurality of sound sources, using particle filtering, comprises:
computing a probability that a potential source is a real source.

45. A sound source localizing and tracking method as defined in claim 35, wherein simultaneously tracking the plurality of sound sources, using particle filtering, comprises:
computing a probability that a real source corresponds to a potential source detected by the sound source detector.

46. A sound source localizing and tracking method as defined in claim 43, wherein simultaneously tracking the plurality of sound sources, using particle filtering, comprises:
computing (a) at least one of a probability that a sound source is observed and a probability that a real sound source corresponds to a potential sound source, and (b) a probability density of observing a sound source at a given particle position; and
computing updated particle weights in response to said probability density and said at least one probability.

47. A sound source localizing and tracking method as defined in claim 35, wherein simultaneously tracking the plurality of sound sources, using particle filtering, comprises:
adding a new source when a probability that the new source is real is higher than a first threshold.

48. A sound source localizing and tracking method as defined in claim 47, wherein simultaneously tracking the plurality of sound sources, using particle filtering, comprises assuming that the added new source exists if a probability of existence of said new source reaches a second threshold.

49. A sound source localizing and tracking method as defined in claim 35, wherein simultaneously tracking the plurality of sound sources, using particle filtering, comprises:
removing a sound source when the latter source has not been observed for a certain period of time.

50. A sound source localizing and tracking method as defined in claim 43, wherein simultaneously tracking the plurality of sound sources, using particle filtering, comprises:
estimating a position of each source as a weighted average of the positions of its particles, said estimator being responsive to the calculated, updated particle weights.

51. A method for localizing at least one sound source, comprising:
detecting sound from said at least one sound source through a set of spatially spaced apart sound sensors to produce corresponding sound signals; and
localizing, in a single step, said at least one sound source in response to the sound signals, localizing said at least one sound source including steering a frequency-domain beamformer in a range of directions.

52. A sound source localizing method as defined in claim 51, wherein localizing, in a single step, said at least one sound source comprises:
computing sound power spectra and cross-power spectra of sound signal samples in overlapping windows;
computing cross-correlations by averaging the cross-power spectra over a given period of time;
computing an output energy of the steered beamformer from the calculated cross-correlations; and
finding a loudest sound source localized in a given direction, the given direction of the loudest sound source being found by maximizing the output energy of the steered beamformer.

53. A sound source localizing method as defined in claim 52, wherein computing the cross-correlations comprises:
computing, in the frequency domain, whitened cross-correlations; and
applying a weighting function to the computed whitened cross-correlations to act as a mask based on a signal-to-noise ratio.

54. A sound source localizing method as defined in claim 53, comprising modifying the weighting function by including a reverberation term in a noise estimate in order to make the method more robust to reverberation.

55. A sound source localizing method as defined in claim 51, wherein localizing, in a single step, said at least one sound source comprises:
defining a uniform triangular grid for the surface of a sphere to define directions;
computing sound power spectra and cross-power spectra of sound signal samples in overlapping windows;
computing cross-correlations by averaging the cross-power spectra over a given period of time;
pre-computing a table of time delays of arrival for each pair of sound sensors and each direction on the grid of the sphere; and
finding a loudest sound source in a direction of the grid of the sphere, finding the loudest sound source comprising searching a best direction on the grid of the sphere using a first algorithm and the pre-computed table by maximizing an output energy of the steered beamformer.

56. A sound source localizing method as defined in claim 55, comprising finding another sound source, using a second algorithm, after having removed the contribution of the located, loudest sound source.

57. A sound source localizing method as defined in claim 55, wherein localizing, in a single step, said at least one sound source further comprises:
defining a refined grid for the surrounding of a point where a sound source was found in order to find a direction of localization of the found sound source with improved accuracy.

58. A method for tracking a plurality of sound sources, comprising:
detecting sound from the sound sources through a set of spatially spaced apart sound sensors to produce corresponding sound signals; and
simultaneously tracking the plurality of sound sources, using particle filtering responsive to the sound signals from the sound sensors.

59. A sound source tracking method as defined in claim 58, wherein simultaneously tracking the plurality of sound sources, using particle filtering, comprises modeling each sound source using a number of particles having respective directions and weights.

60. A sound source tracking method as defined in claim 58, wherein simultaneously tracking the plurality of sound sources, using particle filtering, comprises:
computing a probability that a potential source is a real source.

61. A sound source tracking method as defined in claim 58, wherein simultaneously tracking the plurality of sound sources, using particle filtering, comprises:
computing a probability that a real source corresponds to a potential source detected by the sound source detector.

62. A sound source tracking method as defined in claim 59, wherein simultaneously tracking the plurality of sound sources, using particle filtering, comprises:
computing (a) at least one of a probability that a sound source is observed and a probability that a real sound source corresponds to a potential sound source, and (b) a probability density of observing a sound source at a given particle position; and
computing updated particle weights in response to said probability density and said at least one probability.

63. A sound source tracking method as defined in claim 58, wherein simultaneously tracking the plurality of sound sources, using particle filtering, comprises:
adding a new source when a probability that the new source is real is higher than a first threshold.

64. A sound source tracking method as defined in claim 63, wherein simultaneously tracking the plurality of sound sources, using particle filtering, comprises assuming that the added new source exists if a probability of existence of said new source reaches a second threshold.

65. A sound source tracking method as defined in claim 58, wherein simultaneously tracking the plurality of sound sources, using particle filtering, comprises:
removing a sound source when the latter source has not been observed for a certain period of time.

66. A sound source localizing and tracking method as defined in claim 59, wherein simultaneously tracking the plurality of sound sources, using particle filtering, comprises:
estimating a position of each source as a weighted average of the positions of its particles, said estimator being responsive to the calculated, updated particle weights.
